(19) United States
(12) Patent Application Publication
(10) Pub. No.: US 2026/0135812 A1
(43) Pub. Date: May 14, 2026

(54) ADAPTIVE QUALTIY OF SERVICE OPTIMIZATION IN WIRELESS NETWORKS

(71) Applicant: Cisco Technology, Inc., San Jose, CA (US)

(72) Inventors: Ardalan Alizadeh, Milpitas, CA (US); Peiman Amini, Fremont, CA (US); Jerome Henry, Pittsboro, NC (US); Juan Carlos Zuniga, Montreal (CA)

(73) Assignee: Cisco Technology, Inc., San Jose, CA (US)

(21) Appl. No.: 19/278,490

(22) Filed: Jul. 23, 2025

Related U.S. Application Data
(60) Provisional application No. 63/718,781, filed on Nov. 11, 2024.

(51) Int. Cl. H04L 47/2408; H04L 47/24

(52) U.S. Cl. CPC H04L 47/2408; H04L 47/2458

(57) ABSTRACT

Managing Quality of Service (QoS) policies using real-time traffic analysis, cross-layer feedback, an adaptive policy engine, and security measures may be provided. Managing QoS policies can comprise receiving network data comprising one or more Physical (PHY) layer metrics and one or more Media Access Control (MAC) layer metrics, and determining one or more network conditions based on the network data. An application type of an application is determined by evaluating a packet associated with the application. Then, a QoS mark is set for traffic of the application based on the network conditions and the application type.

### RELATED APPLICATION

This application claims priority to U.S. Provisional Patent Application No. 63/718,781, titled “Adaptive Real-Time QoS Optimization in Wi-Fi Networks,” filed Nov. 11, 2024, the disclosure of which is hereby incorporated by reference in its entirety.

### TECHNICAL FIELD

The present disclosure relates generally to managing Quality of Service (QoS) policies using real-time traffic analysis, cross-layer feedback, an adaptive policy engine, and security measures.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for managing Quality of Service (QoS) policies in accordance with aspects of the present disclosure.

FIG. 2 is a block diagram of a QoS policy system in accordance with aspects of the present disclosure.

FIG. 3 is a block diagram of a QoS management process in accordance with aspects of the present disclosure.

FIG. 4 is a block diagram of security and authentication process for managing QoS policies in accordance with aspects of the present disclosure.

FIG. 5 is a flow chart of a method for managing QoS policies in accordance with aspects of the present disclosure.

FIG. 6 is a block diagram of a computing device in accordance with aspects of the present disclosure.

FIG. 7 is a block diagram of a computing device in accordance with aspects of the present disclosure.

### DETAILED DESCRIPTION

### Overview

Managing Quality of Service (QoS) policies using real-time traffic analysis, cross-layer feedback, an adaptive policy engine, and security measures may be provided. Managing QoS policies can comprise receiving network data comprising one or more Physical (PHY) layer metrics and one or more Media Access Control (MAC) layer metrics, and determining one or more network conditions based on the network data. An application type of an application is determined by evaluating a packet associated with the application. Then, a QoS mark is set for traffic of the application based on the network conditions and the application type.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In Wi-Fi networks, especially in enterprise environments with many different applications and devices, network resources must be managed to ensure that network performance meets client and provider requirements and expectations, real-time application requirements, and utilizes available network features. Traditional Quality of Service (QoS) policy management methods are usually fixed and do not adjust well to changing network conditions, different needs of applications, and changing priorities of users. Because of this, existing methods cannot allocate resources efficiently, leading to important applications not getting the bandwidth and latency required and otherwise affecting network performance.

The presence of mixed-device environments exacerbates the challenge of providing consistent application performance across all devices. Existing systems struggle to dynamically adjust QoS settings in real-time, leading to latency, packet loss, and jitter. Providing real-time applications like VoIP and video conferencing can therefore be problematic. Additionally, the potential for security vulnerabilities and misuse of network priorities, where applications or devices misrepresent their traffic to gain preferential treatment, further complicates effective QoS management.

A dynamic QoS policy system and processes are described herein that leverage real-time adaptability, enhanced security, and cross-layer optimization for addressing these issues. The QoS policy system can perform QoS tagging and management operations for managing (e.g., dynamically setting and adjusting) QoS policies. QoS tagging includes marking network traffic (i.e., packets) with values that indicate how the traffic should be treated as it travels through the network, such as which QoS policies the traffic can access. The tagging enables network devices to prioritize certain traffic over other traffic.

By dynamically assigning and adjusting Differentiated Services Code Point (DSCP) tags based on current network conditions and application needs, integrating secure authentication mechanisms, and utilizing feedback from multiple layers, the QoS policy system can efficiently and fairly allocate resources. This approach enhances the performance of real-time applications, maintains network security, and supports the diverse requirements of a modern enterprise wireless network.

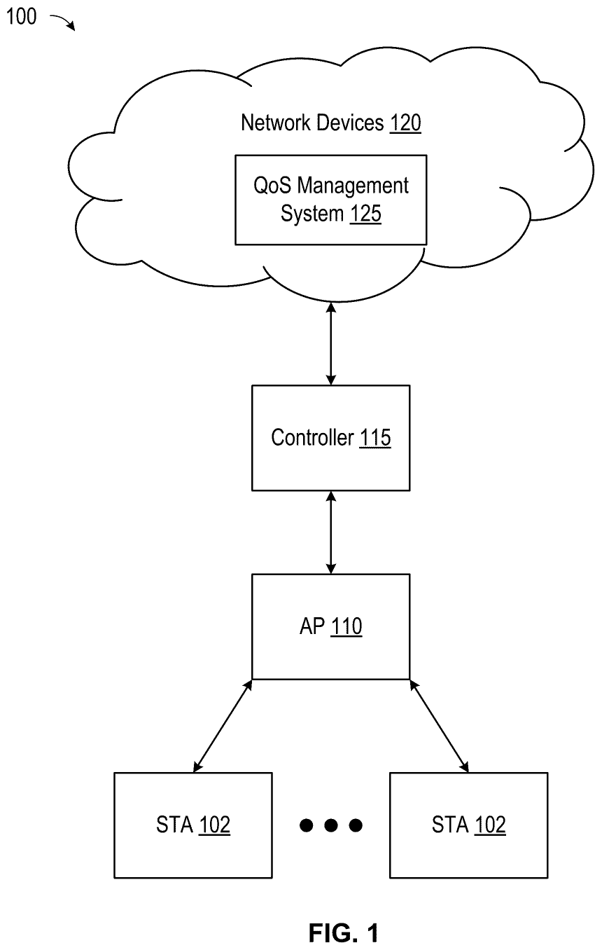

FIG. 1 is a block diagram of an operating environment 100 for managing QoS policies. The operating environment 100 includes Stations (STAs) 102, an Access Point (AP) 110, a controller 115, and network devices 120 in the illustrated embodiment.

The STAs 102 are any device that can wirelessly communicate with the AP 110, such as a personal computer, a smart phone, a server, a video game console, a tablet, a virtual reality device, and the like. The AP 110 is configured to communicate with and/or enable devices such as the STAs 102 to enable communication with the network devices 120. The controller 115 is a network controller, such as a Wireless Local Area Network (WLAN) controller, configured to manage and control the AP 110, the STAs 102, and/or other network devices to allow wireless devices to communicate with the network devices 120. The STAs 102, the AP 110, and the controller 115 can form a WLAN. The AP 110 and/or the controller 115 can include router components or connect to an external router for routing traffic and otherwise managing the operation of the WLAN. In certain embodiments, the AP 110 acts as a controller and the controller 115 is not present in the operating environment 100. For example, the AP 110 can include components to act as a WLAN controller.

The network devices 120 are a set of devices that facilitate communication between senders and destinations, such as by implementing communication protocols. Example network devices 120 can form local area networks, wide area networks, intranets, or the Internet. In certain embodiments, the network device 120 include a QoS management system 125 and/or other systems for dynamically managing QoS policies, such as performing QoS tagging. In some embodiments, one or more components of the QoS management system 125 can be part of and/or processes described as performed by the QoS management system 125 can be performed by another device of the operating environment 100 (e.g., STAs 102, the AP 110, and/or the controller 115).

The operating environment 100 is a computer network with one or more WLANs and/or other networks in example embodiments. A computer network is a geographically distributed collection of nodes interconnected by communication links and segments for transporting data between end nodes (e.g., an STA 102 and an end node of the network devices 120). Many types of networks can be part of the operating environment 100, from local area networks (LANs) to wide area networks (WANs). LANs typically connect the nodes over dedicated private communications links located in the same general physical location, such as a building or campus while WANs typically connect geographically dispersed nodes over long-distance communications links, such as common carrier telephone lines, optical networks, or the like. The Internet is an example WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

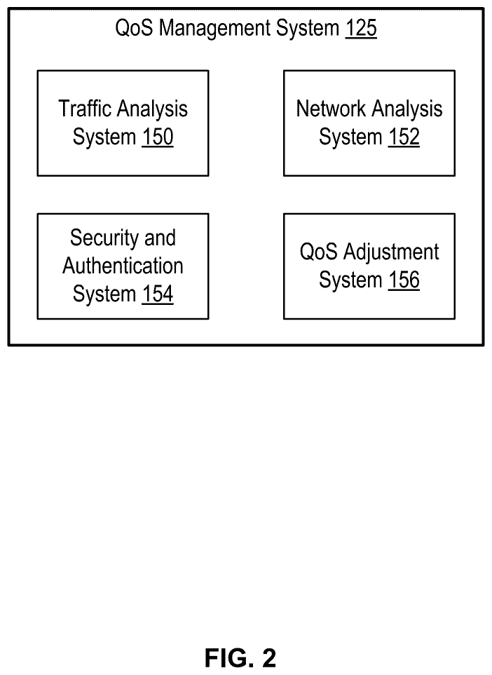

The QoS management system 125 is one or more systems that can be positioned at various locations of the computer network for monitoring and analyzing traffic, adjusting QoS policies, and performing security and authorization processes. The QoS policy system is described in further detail herein with respect to FIG. 2.

An example QoS policy is a queuing or congestion management mechanism such as Low Latency, Low Loss, Scalable Throughput (L4S). L4S is an architecture and protocol described in the Internet Engineering Task Force (IETF) standards (e.g., the IETF Request for Comment (RFC) 9330, 9331, 9332). L4S is implemented to provide low queuing latency, low congestion loss, and scalable throughput control for streaming video, multiplayer games, and other real-time applications. By handling data packet processing and reducing network congestion, L4S minimizes delays caused by queue bloat and enables smoother and more efficient data transmission. Only certain devices (e.g., for the WLAN, only a subset of the STAs 102) may be capable of utilizing L4S. Further, the capable devices should only use L4S for applications, such as real-time applications, which need to use L4S for intended operation.

The QoS management system 125 can dynamically enable and disable L4S for devices of the operating environment 100 and the various applications of the devices so only intended devices and L4S enabled applications utilize L4S. For example, the QoS management system 125 can tag traffic to enable L4S traffic (e.g., higher priority traffic) to travel through the network using L4S and tag traffic to cause classic traffic to travel through the network without using L4S. The QoS management system 125 can similarly control other QoS policies to efficiently allocate resources and improve application performance across the computer network.

In certain embodiments, the devices of the operating environment 100 can use artificial intelligence (e.g., machine learning) techniques, such as to manage QoS policies. The QoS management system 125 can use artificial intelligence techniques to analyze traffic, manage QoS policies, perform security and authentication processes, and/or the like for example. In general, machine learning is concerned with the design and the development of techniques that take data (e.g., network statistics, performance indicators) as input, and recognize complex patterns in the data. One common pattern among machine learning techniques is the use of an underlying model L, whose parameters are optimized for minimizing the cost function associated to the model L, given the input data. For instance, in the context of classification, the model L may be a straight line that separates the data into two classes (e.g., labels) such that L=a*x+b*y+c and the cost function would be the number of misclassified points. The learning process then operates by adjusting the parameters a, b, c such that the number of misclassified points is minimal. After this optimization phase (or learning phase), the model L can be used to classify new data points. Often, the model L is a statistical model, and the cost function is inversely proportional to the likelihood of L, given the input data.

In various implementations, one or more devices of the operating environment 100 employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. Unsupervised techniques do not require a training set of labels. While a supervised learning model may look for previously seen patterns that have been labeled as such, an unsupervised model may instead look to whether there are sudden changes or patterns in the behavior of the attributes. Semi-supervised learning models are a mixed approach that use a reduced set of labeled training data.

Example machine learning techniques that the one or more devices of the operating environment 100 can employ include Nearest Neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), Support Vector Machines (SVMs), Generative Adversarial Networks (GANs), Long Short-Term Memory (LSTM), logistic or other regression, Markov models or chains, Principal Component Analysis (PCA) (e.g., for linear models), Singular Value Decomposition (SVD), Multi-Layer Perceptron (MLP) Artificial Neural Networks (ANNs) (e.g., for non-linear models), replicating reservoir networks (e.g., for non-linear models, typically for timeseries), random forest classification, and/or the like.

In further implementations, the devices of the operating environment 100 are capable of using one or more generative artificial intelligence models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, Generative Adversarial Networks (GANs), Large Language Models (LLMs), other transformer models, and/or the like.

### Managing QoS Policies

FIG. 2 is a block diagram of the QoS management system 125. In the illustrated example, the QoS management system 125 includes a traffic analysis system 150, a QoS adjustment system 156, a security and authentication system 154, and a network analysis system 152. The various components of the QoS management system 125 can be positioned at and/or processes the components perform can be performed at various devices of the operating environment 100, such as the AP 110 and/or the controller 115, in certain embodiments. For example, the AP 110 and/or the controller 115 can monitor and mark (i.e., tag) traffic for managing QoS policies. There can be more or fewer components of the QoS management system 125, the components can perform one or more processes described as being performed by another component, and the like in other embodiments.

The QoS management system 125 is configured to dynamically adjust QoS marking operations, such as in response to network conditions. The QoS management system 125 is also configured to dynamically adjust QoS policies, such as by adjusting QoS policy characteristics. QoS policy characteristics can include QoS marking characteristics, QoS priority characteristics, and/or the like. The QoS marking characteristics can define how traffic is tagged, what types of traffic is tagged, how different tags should be handled, and/or the like. The QoS priority characteristics can define how marked traffic is handled, such as which queues traffic is placed in, queue characteristics, when to indicate congestion in markings, when to drop packets, when to prioritize traffic, and/or the like. The QoS policies can be adjusted based on network conditions, user input, application input, network analytics, and/or the like.

The traffic analysis system 150 monitors network traffic for adjusting the QoS policies. The traffic analysis system 150 can continuously monitor network traffic in real-time using Deep Packet Inspection (DPI) to identify the type of application generating the traffic (e.g., a video call, streaming service, data transfer, etc.). DPI techniques include inspecting the header and payload of packets to identify the type of application associated with the packet. The traffic analysis system 150 can then dynamically assign or adjust DSCP tags for prioritizing or deprioritizing traffic according to its type and current network conditions (e.g., as determined by the network analysis system 152).

The network analysis system 152 analyses the network to determine network conditions. In certain embodiments, the network analysis system 152 utilizes cross-layer feedback. The Open System Interconnection model of networking includes seven abstraction layers for communications between systems. Layer 2 is the data link layer, and layer 3 is the network layer. The data link layer comprises the Logical Link Control (LLC) sublayer and the Medium Access Control (MAC) sublayer and is responsible for transferring data between nodes on a network segment across the Physical (PHY) layer. The network layer is responsible for transferring packets from a source to a destination via one or more networks. The network analysis system 152 can gather real-time data from both the PHY and MAC layers to enable adjustment of QoS policies based on actual network conditions, such as signal quality, interference levels, and congestion, ensuring that the dynamic QoS marking accurately reflects the network's current state.

The QoS management system 125, using the traffic analysis system 150, the network analysis system 152, and/or the like, can evaluate information from various network layers (e.g., the MAC layer, the PHY layer, the network layer), external analytics platforms, and so on. The information from the various network layers can include real-time network conditions such as congestion, signal quality, and interference, providing a comprehensive view of the network's physical and operational state. In example embodiments, the information includes Signal-to-Noise Ratio (SNR), channel utilization, packet error rates, and/or the like.

The QoS management system 125 can evaluate information related to a holistic view of network health, user demands, and application requirements. Users and applications can request priority changes based on operational requirements in certain embodiments, and the QoS management system 125 can utilize user inputs and application priority inputs to dynamically adjust QoS policies based on predefined priorities and real-time demands.

The QoS adjustment system 156 can be cloud-based or integrated within the network infrastructure (e.g., part of one or more devices of the computer network) and can dynamically adjust QoS policies based on the traffic analysis by the traffic analysis system 150 and the network analysis by the network analysis system 152. For example, the QoS management system 125 performs a comprehensive analysis of aggregate network performance data, application demands, and user-defined priorities to determine how to adjust QoS policies. In example implementations, the QoS adjustment system 156 adjusts QoS marking rules (e.g., adjusting DSCP tags) and priority levels (e.g., prioritize or deprioritize traffic types) when adjusting QoS policies.

To ensure the scalability and responsiveness of the QoS adjustment system 156 in example implementations, the QoS adjustment system 156 can utilize cloud computing (e.g., distributed computing) resources and distributed processing techniques. The QoS adjustment system 156 can therefore manage large volumes of data and execute complex analytical processes without introducing significant latency for operation of the QoS adjustment system 156.

The QoS adjustment system 156 is configured to adjust QoS policies for devices and applications, including facilitating seamless and automatic adjustments to QoS marking rules and priorities and optimizing network resource allocation. The QoS adjustment system 156 can analyze patterns or otherwise process network data indicating network congestion, bandwidth availability, application performance metrics, and/or the like to determine how to adjust QoS policies, such as how QoS marks are set for traffic in different network conditions or adjusting QoS policy characteristics. For example, L4S operation can be adjusted by adjusting L4S characteristics such as setting a queue size, setting one or more thresholds for Explicit Congestion Notification (ECN) marking, setting an ECN marking strategy, setting a drop policy, determining a queue management algorithm, setting a target delay, setting an interval period, setting an update period, setting an L4S balancing strategy, and/or the like. In example implementations, the QoS adjustment system 156 determines the QoS policy adjustments so real-time applications receive the necessary bandwidth and latency prioritization, especially during peak network usage periods.

The QoS adjustment system 156 can communicate with the traffic analysis system 150 and/or the network analysis system 152 to analyze extracted application-specific features from network packets (e.g., identified using DPI). For example, the QoS adjustment system 156 can identify protocols and service levels using DPI for traffic. The QoS adjustment system 156 can also apply artificial intelligence techniques such as clustering algorithms (e.g., K-means) to categorize network traffic into distinct patterns, for example based on usage, loss, and latency. Thus, the QoS management system 125 implements DPI and/or other traffic analysis to recognize and prioritize essential traffic effectively.

The QoS management system 125 can predict future network conditions for the QoS policy adjustment determination. In some embodiments, QoS management system 125 (e.g., via the QoS adjustment system 156 and/or the network analysis system 152) uses autoregressive integrated moving average (ARIMA) models for time-series analysis of network congestion to predict future network conditions such as congestion, bottlenecks, and so on. The QoS management system 125 can also use decision tree classifiers for making real-time QoS marking decisions based on network conditions, predicted future network conditions, application needs, and/or the like. The predictive capabilities of the QoS management system 125 can enable proactive adjustments of QoS policies before users experience degradation in application performance.

The QoS adjustment system 156 can also utilize reinforcement learning, such as Q-learning or Deep Q-Network (DQN) algorithms, to optimize QoS policies dynamically based on network conditions in certain embodiments. The reinforcement learning techniques can be combined with real-time data stream analysis for scalable and fault-tolerant processing for adjusting QoS policies. These methods enable the QoS adjustment system 156 to learn and apply optimal QoS strategies efficiently, adapting to changing network environments.

The QoS management system 125 can evaluate ongoing network performance, including the effect the adjustment of QoS policies causes. For example, the QoS management system 125 utilizes a feedback loop that enables devices and applications to report performance experiences including network conditions, application performance metrics, and user experience feedback. The QoS management system 125 can use the feedback to refine the machine learning models, decision algorithms, and/or other operations of the QoS management system 125. Thus, the QoS management system 125 can adapt to evolving needs of devices and applications.

Furthermore, the QoS adjustment system 156 can evaluate the impact its operation has on the network. For example, the QoS adjustment system 156 uses a feedback mechanism to identify the outcomes of QoS adjustments, measuring their impact on application performance and user experience. The QoS adjustment system 156 can then refine its decision-making algorithms and other operations to improve the accuracy and effectiveness of future policy adjustments.

The QoS adjustment system 156 can operate according to a governance framework in some embodiments. For example, a network provider can establish a governance framework that defines clear rules and parameters for QoS adjustments so the QoS adjustment system 156 operates as desired. The governance framework can include considerations for fairness, security, and compliance with regulatory standards, ensuring that the dynamic adjustments made by the engine adhere to all relevant policies and guidelines.

The QoS adjustment system 156 can also provide a user interface for users, such as network administrators, to monitor the policy engine's decisions, adjust configurations, and manually control the QoS adjustment system 156. The user interface may provide transparency into the engine's operations and allows for human oversight, ensuring that the automated operation of the QoS adjustment system 156 is in alignment with the network's objectives.

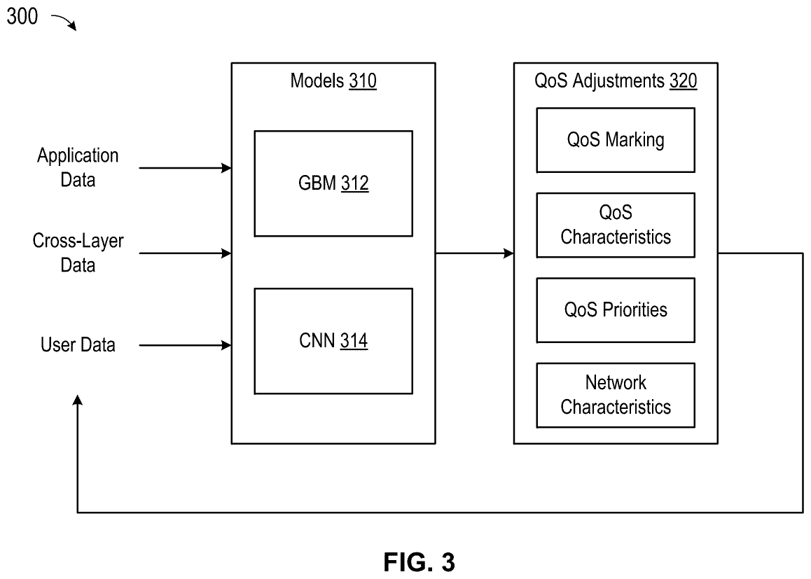

FIG. 3 is a block diagram of a QoS management process 300. The QoS management system 125 is configured to perform the QoS management process 300 in certain embodiments.

The QoS management process 300 begins with data being input into one or more models 310. The data includes cross-layer data, application data, user data, and/or other data associated with network conditions in example implementations. The models 310 comprises a Gradient Boosting Machine (GBM) 312 and a Convolution Neural Network (CNN) 314 in the illustrated embodiment.

The QoS management system 125 can use the GBM 312 to analyze and predict network conditions based on the cross-layer data and/or other data. The GBM 312 may be configured to handle various types of data, including continuous and categorical variables. Thus, the GBM 312 can analyze and predict network conditions based on multiple network metrics like signal quality, congestion levels, and application types.

The QoS management system 125 can use the CNN 314 to process temporal and spatial variations in signal quality and congestion levels. The CNN 314 is configured to effectively capture patterns in multi-dimensional data; therefore, the CNN 313 is operable to analyze time-series data from multiple network segments and recognize patterns indicative of impending congestion or degradation in signal quality before degraded network conditions application performance.

The QoS management system 125 can utilize the combined analyses and predictions of the models 310 to improve its overall accuracy and operation. For instance, the GBM 312 can provide fast, reliable predictions of network conditions, while the CNN 314 can provide insights into complex temporal and spatial patterns. The QoS management system 125 can use the outputs of both models 310 to determine QoS adjustment in the QoS adjustments process 320, for example based on a weighted average or a voting mechanism of predictions from both models 310. The QoS adjustments processes 320 can comprise adjusting QoS marking, QoS characteristics, QoS priorities, and/or network characteristics. Adjustment of network characteristics can include dynamically managing network resources, such as channel and bandwidth allocation, in response to detected changes in network conditions. The QoS management system 125 may continuously perform the QoS management process 300 to continuously manage the computer network.

The QoS management system 125 can identify features the cross-layer data that are most indicative of network performance issues and then use the identified features to determine network conditions. The QoS management system 125 can use selection techniques such as Recursive Feature Elimination (RFE) to identify the most predictive features (e.g., for the models 310). In other embodiments, the QoS management system 125 is instructed on which features indicate network performance issues. The metrics can include packet arrival times, error rates, bandwidth usage, and signal interference levels for example.

To enable real-time analytics, the QoS management system 125 can utilize a streaming data processing framework. This framework can handle real-time data ingestion, processing, and analysis, allowing the QoS management system 125 to use the models 310 to make QoS adjustment decisions based on the latest network conditions.

The QoS management system 125 can continuously learn from new data to increase or maintain effectiveness at managing QoS policies. As network conditions change and new data becomes available, the models 310 are periodically retrained to ensure they adapt to the network's evolving state. The retraining can include techniques like online learning, where the model 310 updates its parameters in response to new data.

To minimize the latency introduced by the cross-layer feedback process, the QoS management system 125 can implement efficient data processing and communication mechanisms such as lightweight protocols for data exchange between layers and the deployment of edge computing resources to process data closer to its source. The efficient data processing and communication mechanisms can reduce response times for QoS adjustments.

### Security and Authentication for Managing QoS Policies

The security and authentication system 154 may comprise secure, cloud-based (e.g., distributed computing) authentication and verification mechanisms configured to prevent misuse, ensure fair resource distribution, and maintain high network security standards. The security and authentication system 154 can verify the legitimacy of devices and applications requesting network resources. For example, the security and authentication system 154 performs certification checks (e.g., cloud based) that ensure only authorized devices can access enhanced QoS settings, preventing unauthorized use and enhancing overall network security. The security and authentication system 154 can also detect and mitigate the misrepresentation of traffic, ensuring that applications or devices cannot falsely claim priority status. To enable access to authorized devices and ensure traffic is not misrepresented, the security and authentication system 154 may continuously monitor traffic for anomalies in traffic patterns and implement verification processes for traffic claiming to require utilization of QoS policies such as L4S.

In some embodiments, the security and authentication system 154 certifies devices, such as the STAs 102, the AP 110, and/or other devices of the operating environment 100. For example, the security and authentication system 154 generates and assigns device identifiers (e.g., digital certificates) so devices can be uniquely identified and verified as authorized to access QoS policies. Thus, the device identifiers indicate which QoS policies a device can access.

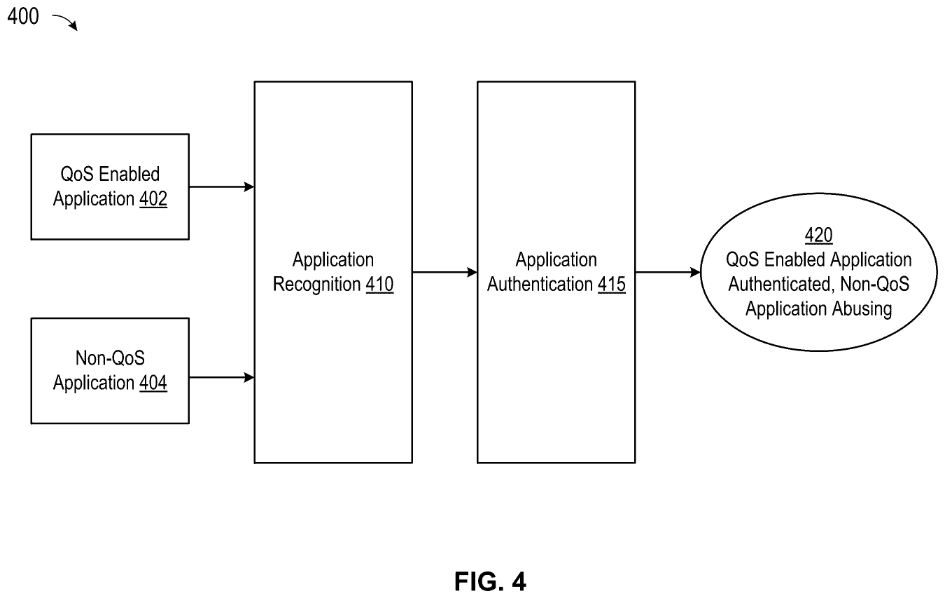

FIG. 4 is a block diagram of security and authentication process 400 for managing QoS policies. The security and authentication system 154 can perform the security and authentication process 400 in example implementations. The security and authentication process 400 includes evaluating traffic from one or more devices. The traffic can be associated with applications that require one or more QoS policies (e.g., L4S for cloud gaming, virtual reality, video conferencing, etc.) and applications that do not require QoS policies. For example, the security and authentication system 154 can receive or otherwise evaluate traffic from a QoS enabled application 402 (e.g., an application that will benefit from L4S) and traffic from a non-QoS application 404.

The security and authentication system 154 can utilize Network-Based Application Recognition (NBAR) technology to classify and identify services and applications on the network. In some embodiments, the security and authentication system 154 performs an application recognition process 410 to identify the application types for the QoS enabled application 402 and the non-QoS application 404. Thus, the security and authentication system 154 identifies that the QoS enabled application 402 should use or otherwise benefit from one or more QoS policies and the non-QoS application 404 should not. The security and authentication system 154 can utilize the device identifiers for identifying the applications in example implementations.

The security and authentication system 154 can then perform an application authentication process 415 to determine whether applications can use a QoS policy. For example, the security and authentication system 154 can authenticate that the QoS enabled application 402 can use a QoS policy such as L4S. If the non-QoS application 404 is attempting to use a QoS policy, the security and authentication system 154 can determine the non-QoS application 404 is impermissibly attempting to use or is using a QoS policy.

The security and authentication system 154 can utilize the device identifiers for authenticating the applications in example implementations. For example, the device identifier associated with the QoS enabled application 402 may indicate that the device can use a QoS policy for that application. The device identifier associated with the non-QoS application 404 (e.g., the same device identifier as the QoS enabled application 402 or another device identifier) may indicate the device cannot use the QoS policy the non-QoS application 404 is attempting to use.

The security and authentication system 154 can generate an authentication output 420 identifying when applications are authenticated for using a QoS policy and when applications are identified as QoS policy abusers. The QoS management system 125 can then cause abusing devices to stop abusing QoS policies. By authenticating traffic with required QoS levels, the security and authentication system 154 ensures that only legitimate and recognized applications can request and access intended QoS policies, preventing unauthorized access and misuse of network resources.

In some embodiments, the security and authentication system 154 continuously evaluates the security posture of devices and applications requesting QoS policy access. The security and authentication system 154 can use a combination of static credentials, such as the device identifiers, and dynamic indicators, such as behavior analysis and reputation scores, to perform the evaluation. The evaluation can include assessing and authorizing requests and adapting to emerging threats and changing network conditions.

To mitigate potential security risks associated with the operation of the security and authentication system 154, such as the evaluation of the traffic and authorization process, an encryption layer can be used for QoS marking information. Thus, the details of QoS assignments are protected from eavesdropping or tampering devices, maintaining the integrity of the QoS enhancement process.

The security and authentication system 154 can continuously monitor the usage patterns and network behavior of authenticated devices and applications for performing authentication processes like the security and authentication process 400. The security and authentication system 154 is configured to detect anomalies or breaches in real-time, enabling immediate response to potential security threats or policy violations and maintaining a secure and trustworthy QoS policy framework.

In certain embodiments, an audit and logging mechanism is implemented. For example, the security and authentication system 154 records all QoS assignment changes, authentication attempts, and device or application activities. The logs are regularly analyzed for signs of security threats, misuse, or system errors, providing a basis for ongoing improvement of the security framework. The security and authentication system 154 can also enable network administrators and users to report suspected security issues or misuse in some embodiments. Thus, the security and authentication system 154 can be responsive to new security challenges and community concerns, reinforcing the overall security and effectiveness of the QoS management system 125.

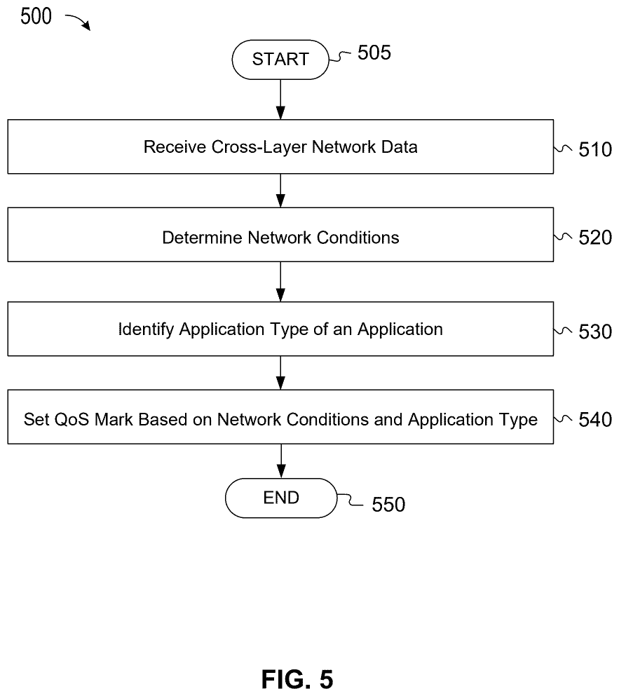

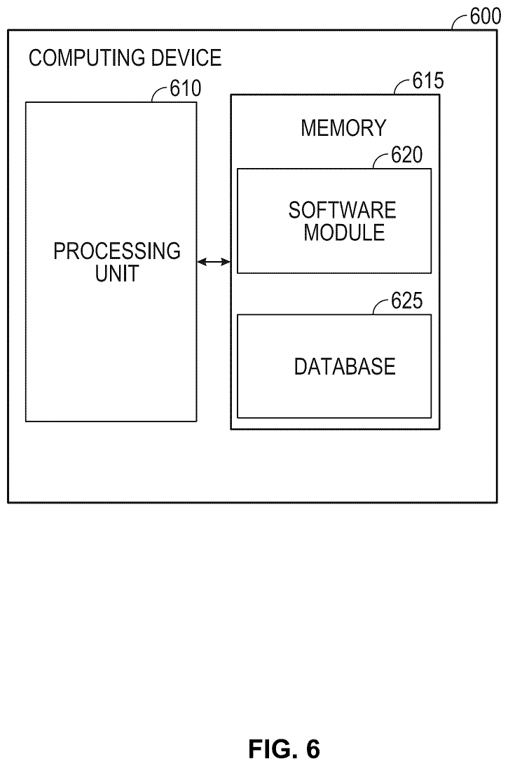

The elements described above of the operating environment 100 (e.g., the STAs 102, the APs 110, the controller 115, the network devices 120, the QoS management system 125, the traffic analysis system 150, the network analysis system 152, the security and authentication system 154, the QoS adjustment system 156, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 5 and 6, the elements of the operating environment 100 may be practiced in a computing device 600 and/or communications device 700.

### Method

FIG. 5 is a flow chart of a method 500 for managing QoS policies. The method 500 can begin at starting block 505 and proceed to operation 510. In operation 510, network data comprising one or more PHY layer metrics and one or more MAC layer metrics is received. For example, the QoS management system 125 receives the cross-layer network data.

In operation 520, one or more network conditions are determined based on the network data. For example, the QoS management system 125 analyzes the network data to determine the network conditions. Determining the network conditions can include using the GBM 312 to determine current network conditions and the CNN 314 to predict future network conditions.

In operation 530, an application type of an application is determined by evaluating a packet associated with the application. For example, the QoS management system 125 perform DPI to identify the application type.

In operation 540, a QoS mark is set for traffic of the application based on the one or more network conditions and the application type. For example, the QoS management system 125 determines how to mark traffic of the application based on the network conditions and the application type. The QoS mark can comprise a DSCP tag.

The method 500 can further comprise adjusting one or more QoS policy characteristics based on the one or more network conditions. In example implementations, the one or more QoS policy characteristics comprises QoS marking characteristics and/or QoS priority characteristics.

The method 500 can further comprise evaluating traffic to identify a traffic type, determining the traffic is not authorized to use a QoS policy based on the traffic type, and preventing the traffic from using the QoS policy. For example, the QoS management system 125 performs security and authentication processes such as described above with respect to and illustrated in FIG. 4. The method 500 can further comprise adjusting a priority of traffic based on the network conditions. The method 500 can conclude at ending block 550.

### Systems

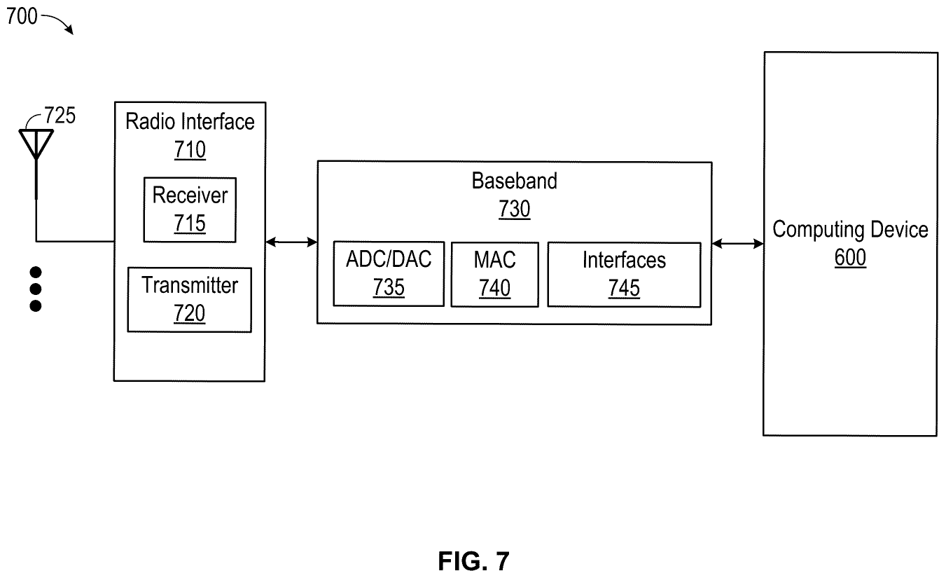

FIG. 7 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for managing QoS policies with respect to FIGS. 1-5. Computing device 600, for example, may provide an operating environment for the STAs 102, the APs 110, the controller 115, the network devices 120, the QoS management system 125, the traffic analysis system 150, the network analysis system 152, the security and authentication system 154, the QoS adjustment system 156, and the like. The STAs 102, the APs 110, the controller 115, the network devices 120, the QoS management system 125, the traffic analysis system 150, the network analysis system 152, the security and authentication system 154, the QoS adjustment system 156, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

FIG. 7 illustrates an implementation of a communications device 700 that may implement one or more of the STAs 102, the APs 110, the controller 115, the network devices 120, the QoS management system 125, the traffic analysis system 150, the network analysis system 152, the security and authentication system 154, the QoS adjustment system 156, etc., of FIGS. 1-5. In various implementations, the communications device 700 may comprise a logic circuit. The logic circuit may include physical circuits to perform operations described for one or more of the STAs 102, the APs 110, the controller 115, the network devices 120, the QoS management system 125, the traffic analysis system 150, the network analysis system 152, the security and authentication system 154, the QoS adjustment system 156, etc., of FIGS. 1-5, for example. As shown in FIG. 7, the communications device 700 may include one or more of, but is not limited to, a radio interface 710, baseband circuitry 730, and/or the computing device 600.

The communications device 700 may implement some or all of the structures and/or operations for the STAs 102, the APs 110, the controller 115, the network devices 120, the QoS management system 125, the traffic analysis system 150, the network analysis system 152, the security and authentication system 154, the QoS adjustment system 156, etc., of FIGS. 1-5, storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or PHY processing circuit for the PHY link layer processing of respective receive/transmit signals. Baseband circuitry 730 may include, for example, a MAC processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving network data comprising one or more Physical (PHY) layer metrics and one or more Media Access Control (MAC) layer metrics;
determining one or more network conditions based on the network data;
identifying an application type of an application by evaluating a packet associated with the application; and
setting a Quality of Service (QoS) mark for traffic of the application based on the one or more network conditions and the application type.

2. The method of claim 1, further comprising adjusting one or more QoS policy characteristics based on the one or more network conditions.

3. The method of claim 2, wherein the one or more QoS policy characteristics comprises any one of (i) one or more QoS marking characteristics, (ii) one or more QoS priority characteristics, or (iii) both (i) and (ii).

4. The method of claim 1, wherein the QoS mark comprises a Differentiated Services Code Point (DSCP) tag.

5. The method of claim 1, further comprising:
evaluating traffic to identify a traffic type;
determining the traffic is not authorized to use a QoS policy based on the traffic type; and
preventing the traffic from using the QoS policy.

6. The method of claim 1, wherein determining the one or more network conditions comprises:
using a gradient boosting machine to determine one or more current network conditions based on the network data; and
using a convolutional neural network to determine one or more future network conditions based on the network data.

7. The method of claim 1, further comprising adjusting a priority of traffic based on the one or more network conditions.

8. A system comprising:
a memory storage; and
a processing unit coupled to the memory storage, wherein the processing unit is operative to:
receive network data comprising one or more Physical (PHY) layer metrics and one or more Media Access Control (MAC) layer metrics;
determine one or more network conditions based on the network data;
identify an application type of an application by evaluating a packet associated with the application; and
set a Quality of Service (QoS) mark for traffic of the application based on the one or more network conditions and the application type.

9. The system of claim 8, the processing unit being further operative to adjust one or more QoS policy characteristics based on the one or more network conditions.

10. The system of claim 9, wherein the one or more QoS policy characteristics comprises any one of (i) one or more QoS marking characteristics, (ii) one or more QoS priority characteristics, or (iii) both (i) and (ii).

11. The system of claim 8, wherein the QoS mark comprises a Differentiated Services Code Point (DSCP) tag.

12. The system of claim 8, the processing unit being further operative to:
evaluate traffic to identify a traffic type;
determine the traffic is not authorized to use a QoS policy based on the traffic type; and
prevent the traffic from using the QoS policy.

13. The system of claim 8, wherein to determine the one or more network conditions comprises to:
use a gradient boosting machine to determine one or more current network conditions based on the network data; and
use a convolutional neural network to determine one or more future network conditions based on the network data.

14. The system of claim 8, the processing unit being further operative to adjusting a priority of traffic based on the one or more network conditions.

15. A non-transitory computer-readable medium that stores a set of instructions which when executed perform a method executed by the set of instructions comprising:
receiving network data comprising one or more Physical (PHY) layer metrics and one or more Media Access Control (MAC) layer metrics;
determining one or more network conditions based on the network data;
identifying an application type of an application by evaluating a packet associated with the application; and
setting a Quality of Service (QoS) mark for traffic of the application based on the one or more network conditions and the application type.

16. The non-transitory computer-readable medium of claim 15, the method executed by the set of instructions further comprising adjusting one or more QoS policy characteristics based on the one or more network conditions.

17. The non-transitory computer-readable medium of claim 16, wherein the one or more QoS policy characteristics comprises any one of (i) one or more QoS marking characteristics, (ii) one or more QoS priority characteristics, or (iii) both (i) and (ii).

18. The non-transitory computer-readable medium of claim 15, wherein the QoS mark comprises a Differentiated Services Code Point (DSCP) tag.

19. The non-transitory computer-readable medium of claim 15, the method executed by the set of instructions further comprising:
evaluating traffic to identify a traffic type;
determining the traffic is not authorized to use a QoS policy based on the traffic type; and
preventing the traffic from using the QoS policy.

20. The non-transitory computer-readable medium of claim 15, wherein determining the one or more network conditions comprises:
using a gradient boosting machine to determine one or more current network conditions based on the network data; and
using a convolutional neural network to determine one or more future network conditions based on the network data.
